(19) United States
(12) Patent Application Publication
(10) Pub. No.: US 2007/0119923 A1
(43) Pub. Date: May 31, 2007

(54) Biometric authentication

(76) Inventors: Jane Ransom Garrison, Austin, TX (US); Dustin Michael Davis, Round Rock, TX (US); Theodore Eric Weber, Round Rock, TX (US); Ronald Richard Smith, Leander, TX (US)

Correspondence Address: KENYON & KENYON LLP, 1500 K STREET N.W., SUITE 700, WASHINGTON, DC, 20005, US

(21) Appl. No.: 11/529,391

(22) Filed: Sep. 29, 2006

Related U.S. Application Data
(60) Provisional application No. 60/721,995, filed on Sep. 30, 2005.

(51) Int. Cl. G06K 5/00

(52) U.S. Cl. 235/380

(57) ABSTRACT

A system and method for tokenless authentication. A customer can enroll with a customer identifier and by providing biometric samples. A customer checking, credit or debit account can be associated with the information provided by the customer. When the customer seeks to enter into a transaction, the customer provides his identifier and biometric information. The identifier can be used to locate the biometric information stored for the customer during enrollment. If the received biometric matches the stored biometric, the customer can be authenticated and the transaction approved.

This application claims priority to U.S. provisional Application No. 60/721,995 filed on Sep. 30, 2005, the disclosure of which is hereby incorporated by reference in its entirety.

### FIELD OF THE INVENTION

The field of the invention is authentication, and in particular biometric authentication in commercial transactions.

### BRIEF DESCRIPTION OF THE DRAWINGS

FIG. 1 shows an enrollment flow in accordance with an embodiment of the present invention.

FIG. 2 shows a real-time, non-integrated payment task flow in accordance with an embodiment of the present invention.

FIG. 3 shows a real-time, integrated payment task flow in accordance with an embodiment of the present invention.

FIG. 4 shows an inquiry task flow in accordance with an embodiment of the present invention.

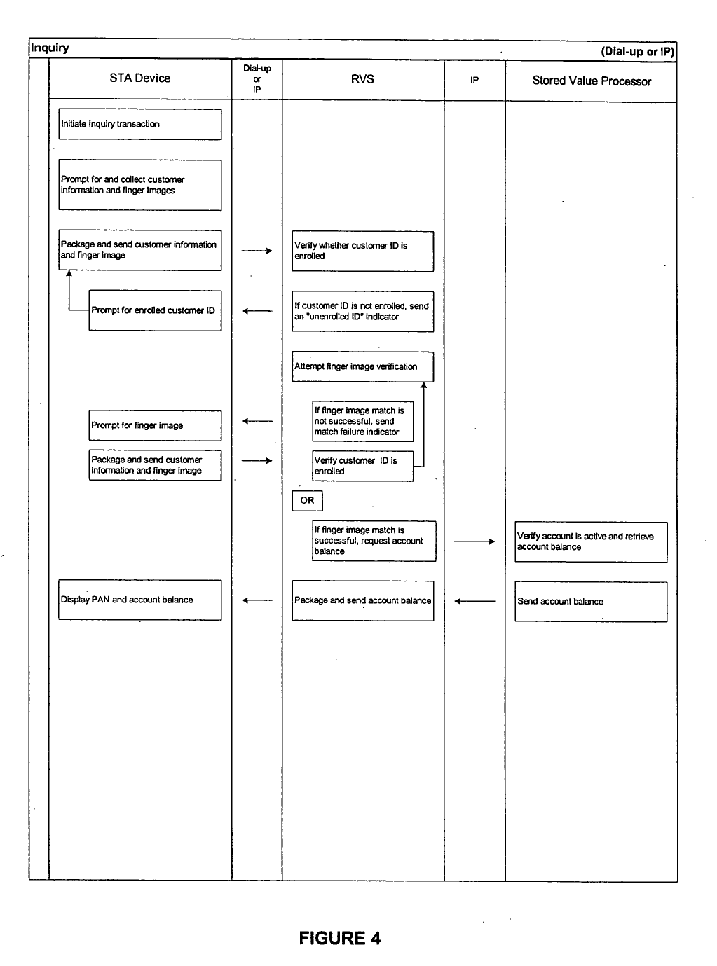

### DETAILED DESCRIPTION

A party such as an organization (e.g., a university) or an individual merchant may desire to provide alternative methods of payment for its customers. The organization may include many points of sale (“POS”) for various goods and services and serve a population that does not have ready access to credit. For example, in a university, students may not generally have access to credit. In the case of an individual merchant, particular customers may not have access to credit, or may wish to pay the equivalent of cash, but in an electronic context. To serve these populations, the organization or merchant can become a member of the prepaid system in accordance with an embodiment of the present invention.

In accordance with an embodiment of the present invention, a terminal adapted to receive biometric and other information from a customer (such as a SecureTouch Advanced (“STA”) device, some other Electronic Funds Transfer terminal, etc.) can be located at a merchant. The STA can be coupled to an authentication server (also known as a Retail Verification System (“RVS”) server) through a network. The authentication server runs RVS application software that performs at least some of the functions of authenticating biometric and other data. A plurality of STAs can communicate with the authentication server over the network though an entity with hardware and software for providing an aggregation point for such communication (an “aggregator.”) The authentication server can be hardware and software (including the RVS application) that can provide biometric authentication, STA command and control, account number retrieval, reconciliation services for transactions between a customer, merchant and Stored Value Processor (“SVP,”) etc. The SVP can be coupled to the network and include hardware and software for storing, and authorizing and/or manipulating stored value accounts. A web services provider can also be coupled to the network and can include hardware and software for providing a web-based graphical user interface views for customers, merchants and the system administrator. Other entities, such as banks and Automated Clearinghouse processors can also be coupled to the network. The network can be any suitable local or wide area network, the Internet, or the Public Switched Telephone Network. For example, the STA device can be coupled to the authentication server via dial-up lines. A Stored Value Processor server is also coupled to the network.

A merchant participant in the prepaid system can be provided with a STA device through which a customer can authorize a transaction by providing an identifier such as a user id as well as biometric information for authentication. Data sent from each STA device can include a fingerprint and a unique STA device identifier. The functions and interactions of the STA device, Retail Verification System server (which executes a RVS application) and Stored Value Processor are described in more detail below.

In certain known systems, the validity of a STA device or any other device that can include a biometric reader is established by receiving a STA device identifier and determining if the identifier corresponds to a valid STA device, e.g., by comparing the received identifier with a list of valid identifiers. This can take time and slow the transaction process and can be prone to errors. In accordance with an embodiment of the present invention, the STA device need not be validated at all. For example, a minimum transaction amount can be established below which the STA device is not verified because the risk of approving a bad transaction for such an amount is deemed to be acceptable. In another embodiment, the STA device is validated without using an STA device identifier. For example, communications between the STA device and the recipient of a message from the STA device can be encrypted. A STA message can be decrypted by a recipient only if the sending STA device has and uses the correct cryptographic key material. Such key material can be distributed and protected in ways known in the art, e.g., using appropriate key distribution schemes, storing the key material in tamper resistant hardware, etc. The fact that a recipient can successfully decrypt a message purportedly sent from a STA can constitute sufficient assurance that the sending STA device is valid. In yet another embodiment, an identifier received from a STA device is validated using a self-authenticating algorithm, i.e., by testing the received identifier for mathematical properties that only valid identifier can have, and which would be practically impossible to imitate by an unauthorized identifier. Such self- authenticating identifiers can be encrypted between the STA device and the RVS server.

A seller and/or payee identification code can also be provided, e.g., via the STA device. In certain known systems, certain payee identification information can be associated with a payee during payee registration. Payee identification information can be provided during a transaction. The system can compare the provided payee identification information with the payee's registered identification data for producing either a successful or failed identification of the payee. If the identification fails, then the transaction can be denied.

Provided payee identification information is not compared with the payee's registered identification data for producing either a successful or failed identification of the payee in accordance with an embodiment of the present invention. For example, a minimum transaction amount can be established below which the received payee identification data is not compared to registered payee identification data for verification because the risk of approving a bad transaction for such an amount is deemed to be acceptable. In an embodiment, the payee identification information can be stored at the STA device and can be automatically sent as a part of the information flow for a transaction. As discussed above, communications (including the payee identifier) between the STA device and the recipient of a message from the STA device can be encrypted. The payee identification data can be decrypted by a recipient only if the sending STA device has and uses the correct cryptographic key material. Such key material can be distributed and protected in ways known in the art, e.g., using appropriate key distribution schemes, storing the key material in tamper resistant hardware, etc. The fact that a recipient can successfully decrypt payee identification information in a message purportedly sent from a STA can constitute sufficient assurance that the payee identifier is valid, thereby rendering any further validation unnecessary. Other techniques, such as hashing and/or digitally signing the payee identifier (or a message or other data containing the payee identifier) or providing for self-authenticating payee identifiers can further diminish any need to validate the payee identifier. A transaction can be approved without comparing the received payee identification information with any other data (such as registered payee identification data), thereby reducing the complexity of transaction processing, saving processor time and reducing the likelihood of error.

Enrollment

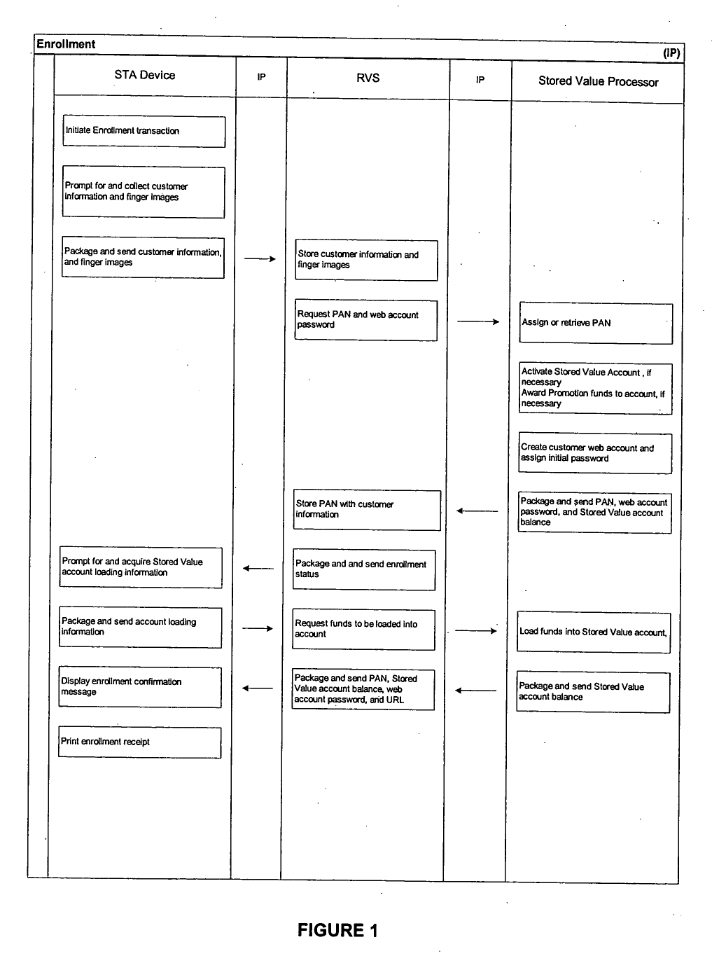

In accordance with an embodiment of the present invention and as shown in FIG. 1, a cashier can trigger an enrollment operation using an STA device, which can prompt for and acquire customer data such as a customer ID number (a user id), a driver license number (or State ID number, resident alien ID number, military ID number, passport number, student ID, etc.), a telephone number, a VIP number (a type of user id that, by (changeable) default, can be set to the customer's telephone number, be constituted by any appropriate characters and subsist in any appropriate format), one or more finger templates, e.g., images from a finger on each hand, scanned images of the customer driver license (or State ID, etc.), a copy of or data from an enrollment form containing customer information, etc.

The STA device can send customer data over any suitable network (e.g., over the Internet, over the Public Switched Telephone Network, over a WAN or LAN, GPRS or cellular network, etc.) to a RVS application. The RVS application can send data such as a University ID, University Promotion ID, and the customer's Student or Faculty ID number to a Stored Value Processor as part of a request to activate a stored value account for the customer. The Stored Value Processor can activate a stored value account for the customer and assign to it an identifier such as a Primary Account Number (“PAN”). The Stored Value Processor can establish a web account for the customer and create a password to be used by the customer to at least initially access the account over an Internet interface, e.g., via a stored value account web site. This can be established, maintained and operated by any suitable party, e.g., the SVP, a web services entity, etc.

The Stored Value Processor can determine if an enrollment promotion is active for a user of an embodiment of the present invention, such as a University. Such an enrollment promotion could offer to students to deposit some dollar amount or points for future redemption to a new stored valued account at no cost to the student as an incentive to establish such an account. If an enrollment promotion is active, the Stored Value Processor can load promotional funds into the customer's account in accordance with the terms of the promotion. The Stored Value Processor can return the customer's PAN, initial web account password, and Stored Value account balance to the RVS application. The RVS application can store the PAN with the customer's enrollment information and can return an indication of the enrollment's success or failure to the STA device.

Upon a successful enrollment, the STA device can prompt the customer to indicate whether the customer would like to load funds into his Stored Value account. If the customer requests that funds are to be loaded, then the STA device can prompt the cashier to enter the amount the customer wants to load, as well as an indication as to the source of the funds (e.g., cash, checking, credit, etc.) The STA device can pass the customer's PAN, the amount to be loaded, and the source of the funds to the RVS application. The RVS application can pass the customer's PAN, the amount to be loaded, and the source of the funds to the Stored Value Processor, which can cause the appropriate amount to be deducted from the indicated source of the funds, and add the appropriate amount to the customer's stored value account. The Stored Value Processor can return the new account balance to the RVS application.

If the customer does not request that funds be loaded to the account, the STA device can send an indication that the enrollment process is complete to the RVS application. The RVS application can return to the STA device data including the PAN, account balance, initial web account password, and network address information for the interface through which the customer can access information about his stored value account. Such network address information can be a URL for a stored value account web site, etc.

The STA device can display an enrollment completion message to the cashier and customer and can print a receipt for the customer. The receipt can include the customer's PAN, initial web account password, Stored Value account balance, and network address information such as a URL for the Stored Value Processor's web site.

A customer can access his stored value account by, for example, logging on to his account through a user interface at a stored value account web site. This can be done using any suitable computer at any location. The customer can then specifying his PAN and the account's initial password. The customer can be prompted to update his userid and password and to provide personal and demographic data. The data can be stored by the Stored Value Processor.

Depending upon the parameters of the University's current Promotion, an additional award might be given to the customer by the Stored Value Processor upon fulfillment of the customer's web account registration

In accordance with an embodiment of the present invention a customer can enroll via a web site, e.g., through the graphical user interface provided by a system web server. The registration information provided by the customer can include personal information, demographic data, account information, etc. The web server can then contact the Stored Value Processor to establish a stored value account for the customer. The customer can complete its enrollment by submitting his biometric data at an STA enrollment station. When the authentication server receives from the STA device the customer's biometric data, the authentication server can query the web services provider to determine if a PAN has already been assigned to the customer. If so, the authentication server can use that PAN. Otherwise, as above, the authentication server can obtain a PAN from the Stored Value Processor.

Real-time, Non-integrated Payment Task Flow

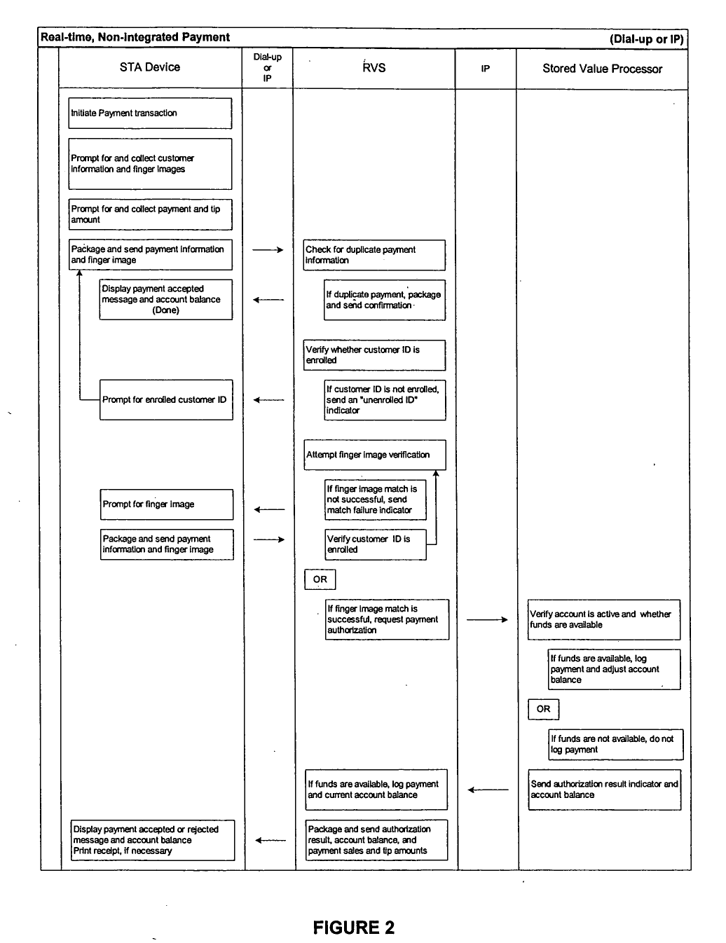

A payment transaction can be initiated in various ways, an embodiment of which is shown in FIG. 2. For example, in accordance with an embodiment of the present invention, a cashier can use an STA device to indicate that an occurring transaction is a Stored Value payment transaction and can enter the transaction amount. The STA device can capture the customer's VIP number or other enrolled ID (Student or Faculty ID, Driver License, etc.) and finger image.

Alternatively, the customer can use the STA device to capture his VIP number or other enrolled ID as well as his finger image. The cashier can be prompted to enter the transaction amount on the STA device, which can prompt the customer to add a tip, if desired, and to confirm the payment amount. If the customer confirms the payment amount, a payment data package can be sent to the RVS application.

For locations supported by a dial-up network connection, the establishment of the communication link between the STA device and the RVS application can take place while the STA device is collecting customer and transaction information. The timing of a pre-dial operation can be configurable within the STA device firmware and can be adjusted during the integration, testing and pilot operation of the system so as to minimize wait time.

Payment data can be sent from the STA device to the RVS application, such as a payment transaction sequence number, a VIP number or other user id, a finger template, a payment amount, which can separately specify a service tip amount, a STA device identifier, a merchant ACH account number, etc.

The RVS application can validate that the STA device from which the payment data originates is a valid, supported device. The RVS application can perform duplication checking of the payment against the most recently logged payment from the STA device. This can be achieved, for example, by determining if the sequence number and transaction data in the current payment data package are the same as those in a previous set of payment data. If so, it can be assumed that although the previous payment was authorized and logged successfully, the STA device did not receive confirmation of the payment. The RVS application can send a confirmation message to the STA device for the previous transaction and does not log the payment again. This feature can also be used to prevent replay attacks, in which an unscrupulous party records a set of valid transaction data and then replays it to the RVS application in an attempt to cause the same transaction to be logged again.

If the sequence number in the current payment data package is the same as that from a previous payment but the transaction data is different, the current payment can be logged by the RVS application and marked as questionable. A dummy confirmation message for the payment can be sent to the EFT terminal. The payment can be included in a set of disputed items for further investigation and analysis.

The RVS application can attempt to verify the customer's live finger template against his enrolled templates. One of several outcomes is possible, such as a successful or unsuccessful biometric match. A failed biometric match may occur, for example, because the person supplying the sample is not the registrant to whom the entered user id belongs, because of an error in the way the biometric data was collected or an error in transmission, because the customer is not registered (enrolled) with the biometric authentication service, etc.

On the other hand, if no biometric match was attempted because the customer did not provide an enrolled ID (a user id), then the RVS application can return an indication of this event to the EFT terminal and an attempt can be made to re-acquire the customer ID. This can be done until the customer provides an enrolled ID, a predetermined retry limit is met, the customer or cashier cancels the payment transaction, etc.

If the customer provides an ID, the new information can be sent to the RVS application server and another verification can be attempted. If a biometric match is attempted but is not successful, then the RVS application can return an indication of this event to the EFT terminal. Further attempts can be made to re-acquire the customer's finger image until, for example, the predetermined retry limit is met or exceeded or the customer or cashier cancels the payment transaction.

If the customer provides a bid biometric sample, it can be sent to the RVS application and another verification can be attempted. If the biometric match is successful, then the RVS application can send to the Stored Value Processor data including the customer's PAN, the transaction amount, the Merchant ID, the STA device ID, the transaction ID, etc. The Stored Value Processor can verify funds availability. The Stored Value Processor can also validate the customer PAN to determine if it belongs to an active Stored Value Account. If this validation fails, the Stored Value Processor can return notice of the invalid PAN to the RVS application and if available, an updated, valid PAN for the customer. Upon receipt of a new PAN, the RVS application can update the customer's enrollment information accordingly.

If funds are available, the Stored Value Processor can inform the RVS application that the transaction is approved and can return the new Stored Value Account balance. The RVS application can log the transaction and returns a “payment accepted” indicator and the account balance to the EFT terminal. If inadequate funds are available, the Stored Value Processor can inform the RVS application that the transaction is not approved and can return the current Stored Value Account balance. The RVS application can return a “payment rejected” indicator and the account balance to the EFT terminal. To make use of the funds in the customer's account, a new payment transaction for an amount not greater than the available funds can be initiated. In the event a transaction is declined, e.g., due to insufficient funds in the account, the customer can be provided with the option of using all or part of the available balance in this account and a cash, credit or payment from some other source to pay in accordance with the transaction. For example, if a customer has five dollars in a prepaid account and approval for a $13.50 transaction is declined due to insufficient prepaid funds, the customer can supplement the prepaid balance with a cash payment of $8.50 to consummate the transaction. Alternatively, the customer can choose to use, for example, $3 from the prepaid account, $4.50 from a separate credit card account and tender $6.50 in cash to make the payment required to consummate the transaction. The EFT terminal can display a transaction completion message to the customer and the cashier. The message can include the Stored Value account balance.

A printer can be attached to the EFT terminal and can print a receipt with the transaction sales amount, tip amount, and Stored Value account balance, and any other appropriate information.

Real-time, Integrated Payment Task Flow

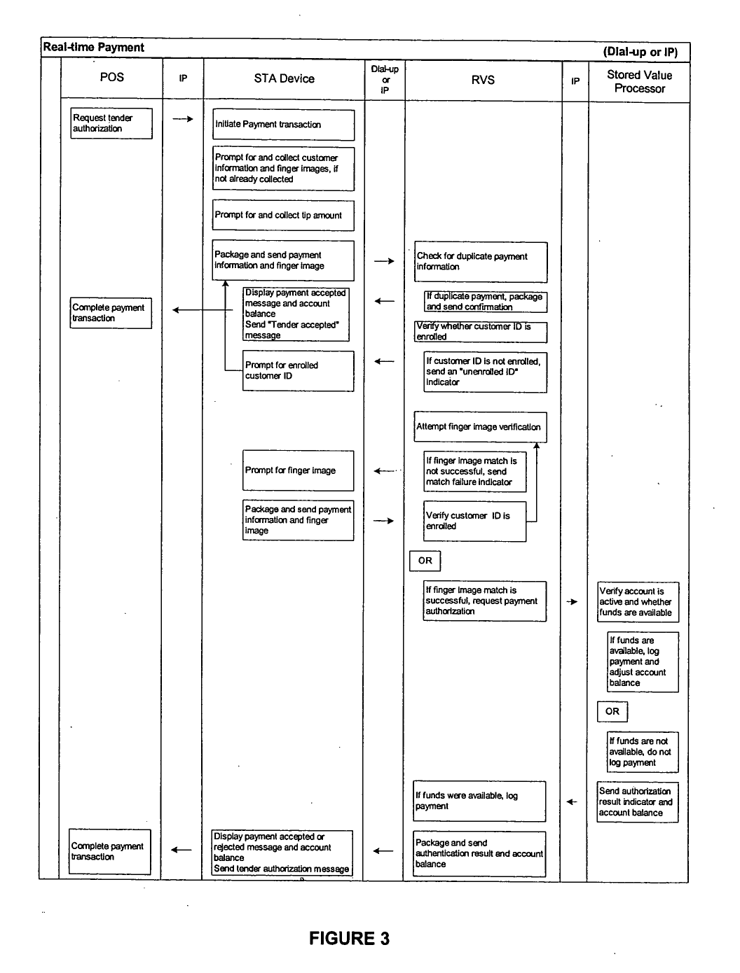

An embodiment of the present invention can include a real-time, integrated payment system and method, an example of which is shown in FIG. 3. A payment transaction can be initiated when the POS system can request a Stored Value tender authorization from the EFT terminal (the STA device.) In the process, the POS system can pass to the EFT terminal a transaction amount along with the request. The EFT terminal can capture the customer's finger image and VIP number or other user id, such as a student identifier, faculty identifier, driver license, etc.

Alternatively, the customer can provide his VIP number and/or other user id through the EFT terminal, which can capture the customer's finger image. The EFT terminal can store this information until it receives a tender authorization request from the POS system, or else until a predetermined transaction timeout period expires.

The EFT terminal can prompt the customer to add a service tip to the transaction, if desired, and to confirm the payment amount. If the customer confirms the payment amount, a payment data package can be sent to the RVS application. For POS locations using a dial-up telecommunications connection to the RVS application, the establishment of a communication link between the EFT terminal and the RVS application can be initiated and possibly completed while the EFT terminal is collecting customer and transaction information. The timing of the pre-dial operation can be configured within the EFT terminal firmware and can be tuned during integration testing and pilot operation of the system to minimize wait time for a connection.

The payment data package sent from the EFT to the RVS application can include a payment transaction sequence number, a VIP number or other user id, a finger template, a payment amount, including a separate designation for a service tip, a STA device ID, a merchant ACH account number, etc. The RVS application can validate that the STA device used in the transaction as a valid, supported device. This validation can be performed without comparing the STA or a merchant identifier with a list of valid STA or merchant identifiers, respectively, as described above. Alternatively, such STA device validation may not be necessary and may not be performed.

The RVS application can check for duplicate payments by checking the present transaction against the previously logged payment from the EFT terminal. If the sequence number and transaction data in the current payment data package are the same as those from the previous payment, it can be assumed that although the previous payment was authorized and logged successfully, the EFT terminal did not receive confirmation of the payment. The RVS application can send a confirmation message to the EFT terminal and would not log the payment again.

If the sequence number in the current payment data package is the same as that from the previous payment but the transaction data is different, then the current payment can be logged by the RVS application and marked as questionable. A dummy confirmation message for the payment can be sent to the EFT terminal. The payment can be included in the next set of disputed items for further investigation and analysis.

The RVS application can attempt to verify the customer's live biometric template against his enrolled templates. There may be a successful biometric match or a failed biometric match. The failed biometric match may occur because the customer is not enrolled in the system, there was an error in collecting or transmitting the live template, etc. If no biometric match was attempted because the customer did not provide an enrolled ID, then the RVS application can return an indication of this event to the EFT terminal. An attempt can be made to re-acquire the customer ID, e.g., until the customer provides an enrolled user id, the configured retry limit is met or exceeded, the customer or cashier cancels the payment transaction, etc.

If the customer provides a user id, the new information can be sent to the RVS application server and another verification can be attempted. If an attempted biometric match is not successful, the RVS application can return an indication of this event to the EFT terminal. Further attempts can be made to re-acquire the customer's biometric image until the configured retry limit is exceeded, the customer or cashier cancels the payment transaction, etc.

If the customer provides a finger image, it can be sent to the RVS application and another verification can be attempted. If the biometric match is successful, then the RVS application can send to the Stored Value Processor the customer's PAN, the transaction amount, the Merchant ID, the STA terminal ID, and the transaction ID, etc.

The Stored Value Processor can then verify funds availability. The Stored Value Processor can also validate the customer PAN to determine if it belongs to an active Stored Value Account. If this validation fails, the Stored Value Processor can return notice of the invalid PAN to the RVS application and if available, return an updated, valid PAN for the customer. Upon receipt of a new PAN, the RVS application can update the customer's enrollment information accordingly.

If funds are available, the Stored Value Processor can inform the RVS application that the transaction is approved and can return the new Stored Value Account balance. The RVS application can log the transaction and can return a “payment accepted” indicator and the account balance to the EFT terminal.

If inadequate funds are available, the Stored Value Processor can inform the RVS application that the transaction is not approved and can return the current Stored Value Account balance. The RVS application can return a “payment rejected” indicator and the account balance to the EFT terminal, which the EFT terminal can return to the POS system. To make use of the funds in the customer's account, a new payment transaction for an amount not greater than the available funds can be initiatedas described above, in the event there are insufficient funds in the customer's prepaid account, the customer can use all or part of the prepaid account balance along with other payment instruments and amounts to constitute a sufficient payment to consummate the transaction.

The EFT terminal can display a transaction completion message to the customer and the cashier. The message can include the current stored value account balance. The EFT terminal can send a tender authorization reply to the POS system. The reply can include an authorization code that indicates approval or rejection of the transaction, transaction sales amount, tip amount, stored value account balance, etc.

Inquiry Task Flow

In accordance with an embodiment of the present invention, the customer can initiate an inquiry transaction by keying in his VIP number or other enrolled user id on the EFT terminal, which can then capture his finger image. An inquiry data package can be sent to the RVS application. For locations supported by dial-up, the establishment of the communication link between the EFT terminal and the RVS application can take place while the EFT terminal is collecting customer and transaction information. The timing of the pre-dial operation is configurable within the EFT terminal firmware and can be tuned during integration testing and pilot operation of the system.

The inquiry data package can include data such as the VIP number or other enrolled user id, a finger template, etc. The RVS application can validate that the STA device where the inquiry transaction request originated is a valid, supported device. Alternatively, the STA device need not be validated. The RVS application can attempt to verify the customer's live finger template against his enrolled templates. There is either a successful biometric match or a failed biometric match. If the match failed, it could be because the customer is not enrolled in the system, an error occurred in collecting the biometric sample or entering the user id, an error occurred in transmission, etc. If no biometric match was attempted because the customer did not provide an enrolled ID, the RVS application can return an indication of this event to the EFT terminal and an attempt can be made to re-acquire the customer ID until the customer provides an enrolled user id, the configured retry limit is met or exceeded, the customer cancels the inquiry transaction, etc.

If the customer then provides the user id, the new information can be sent to the RVS application server and another verification can be attempted. If a biometric match is attempted but is not successful, then the RVS application can return an indication of this event to the EFT terminal. Further attempts can be made to re-acquire the customer's finger image the configured retry limit is met or exceeded, the customer cancels the inquiry transaction, etc.

If the customer provides a finger or other biometric image, it can be sent to the RVS application and another verification can be attempted. If the biometric match is successful, then the RVS application can call the Stored Value Processor with the customer's PAN. The Stored Value Processor can retrieve the account balance and return it to the RVS application.

The EFT terminal can display a transaction completion message to the customer and the cashier. The message can include the stored value account balance. If a printer is attached to the EFT terminal, a receipt can be printed with the customer's PAN and stored value account balance.

Store-and-Forward Payment Task Flow

A store-and-forward system and method is provided in accordance with an embodiment of the present invention. This embodiment would be suited for situations in which an order for a product is taken at a first location and payment is made when the product is delivered, e.g., for a pizza making and delivery business.

A first phase of a store-and-forward payment can occur at the merchant location when the customer places his order. At its discretion, the merchant can send a pre-authorization inquiry request to validate that the customer's Stored Value account holds adequate funds to cover the order. The cashier can provide the customer's VIP number or other enrolled user id and the payment transaction amount to an EFT terminal. The EFT terminal can send a pre-authorization data message to the RVS application. The pre-authorization data message can include a VIP number or other user id, payment transaction amount, etc. The RVS application can retrieve the customer's PAN and calls the Stored Value Processor for an account balance inquiry. The Stored Value Processor can retrieve the account balance and can return it to the RVS application. The RVS application can verify whether the account balance is adequate to cover the payment transaction amount.

The RVS application can return an authorization code that indicates approval or rejection of the transaction amount to the EFT terminal, which then can display an appropriate message to the cashier. It is not necessary for the pre-authorization Inquiry to be performed on the same device as is used for the second and third phases of the store-and-forward payment transactions.

A second phase of a store-and-forward payment transaction can take place when an EFT terminal is used to collect payment transaction information at a location where it is not possible for it to connect to the RVS application server, e.g., at a pizza delivery location. The EFT terminal can prompt for and collect data including a VIP number, an additional enrolled primary ID number (e.g., driver license, State ID, military ID), a finger template, a payment amount, including a separately designated service tip. The maximum payment amount and/or tip amount can be set in advance.

The third phase of a store-and-forward payment transaction can occur when the EFT terminal can again connect at the time of payment to the RVS application server. For example, the EFT device is returned with the delivery person to the pizza shop. The cashier can initiate an upload of all the stored transactions by pressing a command key sequence on the EFT terminal on which payment information has been gathered and stored, e.g., during the delivery process.

The EFT terminal can connect to the RVS application server and transfer the stored transaction data. The RVS application server can respond to each transaction to confirm that it has received the transaction data and indicate whether the processing of the transaction resulted in a successful or failed payment to the merchant. If a printer is attached to the EFT terminal, a receipt can be printed with the transaction sales and tip amounts. The EFT terminal can delete stored data for a transaction after it receives confirmation of its receipt. Following the successful transmission of the last stored transaction, the EFT terminal can terminate the connection.

For each stored transaction that it receives, the RVS application can perform a subset of its usual payment processing, including duplicate checking. Retries can be attempted to overcome errors that may have occurred during communications with the RVS application. Transactions that cannot be approved can be noted for later retry, e.g., when the customer is encountered again on a subsequent delivery, when the customer visits the shop in person, etc.

The RVS application can attempt to verify the customer's live finger or other live biometric template against his enrolled templates. There can be a successful biometric match or a failed biometric match. The biometric match can fail for any of the reasons set forth previously, including that the customer is not enrolled in the system, the customer provided another's user id, etc.

If no biometric match is attempted because none of the identifiers provided by the customer correspond to those of an enrolled customer, then the RVS application can log the transaction and mark it as questionable. The payment can be included in a set of transactions marked for further investigation and analysis.

If a biometric match is attempted but is not successful against the templates for the identifier or identifiers provided by the customer and if the customer's Primary ID is enrolled, the RVS application can proceed as if the biometric match was successful. An indication of the transaction's non-match condition can be included with the rest of the data logged by the RVS application for the transaction. If, on the other hand, the customer's Primary ID is not enrolled, the RVS application can log the transaction and mark it as questionable. The payment can be included in the a set of transactions marked for further investigation and analysis.

If the biometric match is successful, the RVS application can send to the Stored Value Processor data including the customer's PAN and the transaction amount. The Stored Value Processor can verify funds availability. The Stored Value Processor can also validate the customer PAN to determine if it belongs to an active stored value account. If this validation fails, the Stored Value Processor can return notice of the invalid PAN to the RVS application and if available, can return an updated, valid PAN for the customer. Upon receipt of a new PAN, the RVS application can update the customer's enrollment information accordingly.

If funds are available, the Stored Value Processor can inform the RVS application that the transaction is approved and can return the new stored value account balance. The RVS application can log the transaction.

If inadequate funds are available, the Stored Value Processor can inform the RVS application that the transaction is not approved and can return the current stored value account balance. The RVS application can log the transaction and mark it as rejected. The payment can be included in a set of transactions marked for further investigation and analysis.

Reconciliation

Periodically, the EFT terminal can send its transaction closing data in a message that is solicited (e.g., pulled) or unsolicited to the RVS application. For example, at a pre-set time each day, the Stored Value Processor can generate a transaction report and place it on its FTP site for pick-up. The RVS application can retrieve the Stored Value Processor's transaction report and can update customer PANs, as directed by account update transactions within the file. The RVS application can also perform a simple reconciliation (i.e., no transaction revision) of payment transactions against its own logged transaction data. The RVS application can notify any appropriate party of any exception (disputed) transactions by generating and archiving a report on the RVS server. Exception transactions can be marked as being on hold pending further investigation and analysis.

The RVS application can initiate ACH processing for reconciled payment transactions and fee transactions. This can be done according to a pre-determined schedule. The RVS application can determine, on a merchant-specific basis, which reconciled transactions may be eligible for processing. This determination can be based on configurable criteria such as transaction age, total transaction amount, ACH transmission frequency, etc. The RVS application can calculate the merchant fees that are owed to any third party, e.g., for payment processing services, for authentication services, etc, The RVS application can generate and transmit a FED-ready file to a payment processor. The file can include data such as a single debit transaction that is equal to the sum of all the stored value credit transactions, for transfer from the account that holds the customers'funds. In other words, the RVS application can aggregate individual transactions into single transactions, which can be more efficient. For each merchant, the RVS application can place into the file a single credit transaction for the transfer of funds to the merchant account for the stored value purchases that occurred at the merchant's location, and for each merchant owing fees to a third party, an aggregated debit transaction for transfer of funds from the merchant's account. The file can also include a single debit and/or credit transaction set for the sum of all “per-click” fees owed to any party.

On a scheduled basis, the RVS application can generate report files for the review and reconciliation of items such as enrollment and payment activity, ACH transaction activity, per- click fee activity, etc.

Merchant Registration

The system and method in accordance with an embodiment of the present invention further can support a registration procedure for participants, such as universities and merchants. The RVS server can include a GUI application for specifying and maintaining information about each participant, such as merchant information (including name, address, phone number, etc.), promotional identifiers, e.g., for universities, STA device identifiers for STA devices that are installed at the university or merchant location, bank account information (such as account and routing (transit) numbers), ACH transaction submission options, etc.

Funding and Replenishment

The RVS can also accommodate the addition of funds to an account. Funds for deposit can be provided to a merchant, e.g., as cash, a debit to a credit card, a debit to a checking account, e.g., using a debit card, a check, etc. The merchant can then issue a credit to the customer account. Alternatively, the customer can directly deposit funds into his account via the web interface and/or via a kiosk, etc. In accordance with an embodiment of the present invention, an incentive can be offered to encourage the customer to utilize certain methods of loading funds into his account. For example, a customer can be offered a certain number of“free” dollars to be added to his account if he transfers funds from his checking account via ACH, rather than, say, his credit card. This can be useful for avoiding a fee that can be charged by a credit card company for the transfer of funds on credit into the customer prepaid account. The customer may also be incentivized via an offer to add reward points to the balance of one or more customer accounts in reward programs. Such incentives can also be used to encourage the customer to deposit funds in certain currencies or at certain times based upon exchange rates.

Merchant Identifiers

In accordance with an embodiment of the present invention, a system administrator can assign a merchant identifier to each new university, merchant or other participant,which can be provided by the Stored Value Processor. The administrator can generate a file periodically (e.g., each day) to inform the Stored Value Processor of new or updated registrations. For each new university and merchant, the Stored Value Processor can set up a web account with an initial password. The RVS application can validate the origin of the payment and inquiry transactions it receives by confirming that each request comes from a STA device that is supported or has not been marked as unsupported. To keep the STA device information current, an administrator can use a device registration GUI application to report out-of-order, re-located, and stolen STA devices. The RVS application can provide a GUI application to an administrator to indicate the resolution of exception transactions (approved or canceled).

For improved security, the account information can be stored in an encoded and/or encrypted format. Traffic between the STA and its host can be encrypted using a suitable encryption algorithm, such as Blowfish. Further, a system administrator can maintain a blacklist that can include identifiers (such as serial numbers) and other information pertaining to devices that have been reported stolen, missing, hijacked, etc. The blacklist can be consulted before a transaction is approved, before a message is accepted from a device, etc.

Non-Biometric Payment Flow

In accordance with an embodiment of the present invention, a customer can order a product (e.g., a student can order a pizza) over the telephone and ask that the cost of the product be charged against his stored value account. The merchant can collect the customer's VIP number and perhaps other identifiers, such as a student identifier. The merchant can enter the VIP number into the STA and can select a “bio bypass” option on the STA when prompted for a fingerprint. This can cause the process to skip the fingerprint prompt. The STA can then query the merchant for the supplemental identification (e.g., the student identifier), which together with the VIP number can provide sufficient information to provide a unique result for a lookup. The STA can also prompt the merchant for his password. This data (the VIP number, supplemental customer identifier and merchant password) can be sent to the authentication server, along with other transaction information, such as the amount of the transaction, a tip amount, etc. If the merchant password is successfully authenticated and the VIP number and supplemental customer identifier results in a unique result for the lookup, then the sale can be authorized and a receipt can be printed, e.g., at the merchant. The receipt can be presented to the customer for the customer to sign at the time the purchased product is delivered.

A hierarchical approach can be taken to verifying biometric samples. For example, a local verification application and database can be located at a store at which customers register their identifiers and biometric information. The local database can store the identifiers and biometrics for customers that have enrolled at that store. The identifiers and biometrics from several stores can be aggregated and stored at a central database. If a customer who has enrolled at one store seeks to be verified at another, the local database at the other store may not have his identifier and biometrics. In that event, the local verification application can send a query that includes the identifier to the central database. This query need not include any customer biometrics. In response to this query, the central database can send to the local verification server the biometrics corresponding to the customer identifier in the query from the local server. The local server can then compare the biometrics received from the customer at the store with the biometrics received from the central database. If they match, the customer can be authenticated and the transaction can be approved.

The foregoing description is meant to illustrate, and not limit, the scope of the present invention. One of skill in the art will appreciate that in light of the teachings of the foregoing examples, the claims can encompass embodiments not explicitly discussed above. For example, while the examples above discuss various functions performed by different parties and devices, these same functions may be performed by other parties and devices than those described. For example, at least some of the functions performed by the Stored Value Processor can be performed by the RVS application. Likewise, at least some of the functions performed by the RVS application can be performed by the SVP or a bank. The functions described above can be distributed among or consolidated on any number of platforms in accordance with any effective deployment of the system. These alternative configurations are meant to be encompassed by the present invention.

What is claimed is:

1. A system for tokenless authentication, comprising:
a terminal adapted to receive biometric and other information from a customer, said terminal storing a terminal cryptographic key adapted to encrypt a message sent from said terminal;
an authentication server adapted to receive a message sent from said terminal, said message encrypted using said cryptographic key, said server storing a server cryptographic key, said server using said server cryptographic key to decrypt said encrypted message, wherein said server authenticates said message based upon the result of the decryption of the message and not upon the comparison of any identifier sent from the terminal with any list of registered terminal identifiers.

2. A system for tokenless authentication, comprising:
a local server adapted to receive a customer identifier and a customer biometric information;
a local database storing registered customer identifiers and registered customer biometric information;
a remote database storing a larger number of registered customer identifiers and registered customer biometric information than is stored at said local database;
said local server adapted to send a query to said remote database if said local database does not store the customer biometric corresponding to the received customer identifier, said query including the customer identifier received by the local server and not including the customer biometric information received by the local server;
responsive to said query, said remote database adapted to send the customer biometric information corresponding to the customer identifier contained in the query to said local server;
said local server comparing said received customer biometric with said remote database customer biometric and to determine if they match.
